(19) United States
(12) Patent Application Publication
(10) Pub. No.: US 2009/0025986 A1
(43) Pub. Date: Jan. 29, 2009

(54) Packaging Machine

(75) Inventors: Elmar Eugen Ehrmann, Bad Groenenbach (DE); Tieme Jan Slomp, Bad Groenenbach (DE); Alexander Schulzki, Stelzenberg (DE)

Correspondence Address: William D Breneman;BRENEMAN & GEORGES, 3150 Commonwealth Avenue, Alexandria, VA, 22305, US

(73) Assignee: MULTIVAC SEPP HAGGENMÜLLER GMBH & CO. KG, Wolfertschwenden (DE)

(21) Appl. No.: 11/918,896

(22) PCT Filed: Apr. 19, 2006
(86) PCT No.: PCT/DE2006/000679

§ 371 Date: Jul. 15, 2008

(30) Foreign Application Priority Data
Apr. 19, 2005 (DE) 10 2005 018 253.4

(51) Int. Cl. G01G 9/00; G01G 13/08

(52) U.S. Cl. 177/1; 177/119

(57) ABSTRACT

Proposed are a weighing device for a packaging machine and a method for weighing packages from a packaging machine, which can be realized in a space-saving manner and/or permit the processing of packages within a large spectrum of package formats. This is achieved according to the invention in that the weight of two or more packages (7′, 7″) and the weight which is changed as a result of the subsequent supply or lead-away of an individual package (7″) or of a number of packages which are to be weighed together are measured, with it being possible for the weight of an individual package (7″) or of a number of packages which are to be weighed together to be determined from the difference between the weights which are determined in this way.

The invention relates to a weighing device and to a weighing method for a packaging and/or labeling machine as per the preambles of claims 1 and 18.

DE 196 09 431 has already disclosed a method and a device for weighing and labeling packages. In said device, individual packages are guided via a weighing belt and are weighed while being transported on the weighing belt. The product is subsequently labeled by means of a labeling unit which is arranged downstream, with the weight indication in particular being printed on. Devices of said type are commercially available as separate weighing and labeling devices and are conventionally joined onto a discharge belt of a packaging machine.

Said type of weighing device must be adapted to the format of the packages which are to be weighed. There must be space on the weighing belt for the largest package which is provided, and therefore said weighing belt must be of correspondingly large dimensions. This however has the result that, when weighing small packages, the belt speed must be correspondingly increased in order to ensure a sufficient product throughput. High transport speeds however bring about problems during weighing and also in the subsequent labeling unit. In particular, the associated label printers are generally limited in terms of speed.

In addition, for individual weighing, the packages passing from the discharge belt of the packaging machine must be separated, as a result of which the expenditure and also the spatial requirement is increased.

It is an object of the invention, in contrast, to propose a device and a method for weighing which can be realized in a space-saving manner and/or permit the processing of packages within a large spectrum of package formats.

Said object is achieved, proceeding from a device and a method of the type specified in the introduction, by means of the characterizing features of claims 1 and 18.

The measures specified in the subclaims permit advantageous embodiments and refinements of the invention.

Accordingly, a device according to the invention and a method according to the invention as per the preambles of claims 1 and 18 are characterized in that the weight of two or more packages and the weight which is changed as a result of the subsequent supply or lead-away of an individual package or of a number of packages which are to be weighed together are measured, with it being possible for the weight of an individual package or of a number of packages which are to be weighed together to be determined from the difference between the weights which are determined in this way.

For this purpose, a device according to the invention is preferably provided with a scale which has a weighing receptacle for two or more packages. In one particular embodiment of the invention, means are provided here for supplying two or more packages of cargoes onto the weighing receptacle and for weighing the two or more packages together, and means for the successive lead-away of the individual packages which are to be weighed or groups of packages which are to be weighed with subsequent weighing of the weight which remains on the weighing receptacle. Here, the weight of a package or the group weight of a group of packages is determined by means of an evaluating unit from the difference between two weight values.

In another embodiment of the invention, a corresponding weighing device is designed such that means for successively supplying two or more packages into the weighing receptacle, with successive weighing of the weight which is situated on the weighing receptacle, and means for the subsequent lead-away of two or more packages which are situated on the weighing receptacle are provided. In this embodiment, too, an evaluation unit for determining the weight of an individual package or the group weight of a group of packages from the difference of two weight values can be provided.

In the first of said embodiments, all of the packages which are to be weighed together are supplied onto the weighing receptacle and are subsequently successively removed from the weighing receptacle individually or in groups depending on the weight values which are to be measured. In the second embodiment, in contrast, the packages which are to be weighed are successively supplied to the weighing receptacle individually or in groups until the maximum number of packages which are to be weighed together is situated on the weighing receptacle. The lead-away from the weighing unit can then take place simultaneously or successively entirely without a weighing process, or without further weighing for a plurality of the packages.

In both cases, on the one hand, the processing of packages within a large spectrum with regard to their size is possible, that is to say it is possible to utilize the full holding capacity of the weighing device even in the case of relatively small packages.

In addition, the throughput primarily of small packages can be increased by the measures according to the invention in comparison with individual weighing, since it is also possible for weighing processes with two or more packages on the weighing receptacle to take place.

In addition, in both cases, the production line is less complex overall. In the first exemplary embodiment, a separation device upstream of the weighing device is dispensed with, while in the second exemplary embodiment, it is possible under some circumstances for any downstream sorting or grouping devices to be dispensed with, since the allocation of the packages can be carried out already on the weighing device. Here, in each case both the individual or group weight and also the total weight can be measured.

As a result of the design according to the invention of the weighing device, it is possible even in the case of a relatively small package format for a relatively large weighing unit to be utilized in that a plurality of packages are weighed simultaneously with their total weight.

For this purpose, the weighing range of the weighing unit is advantageously designed to be so large that the weighing range of the weighing device is greater than or equal to the greatest occurring total weight of the packages.

The weight determination of the individual packages or of a certain number of packages which are to be weighed together can advantageously take place in that the individual packages or the corresponding number of packages which are to be weighed together are supplied to or led away from the weighing station successively. The weight which is to be determined is given here by the change in the weight, which is varied as a result of the lead-away or supply of the package or packages to be weighed, of the packages which are situated on the weighing station. Said change can be determined by calculation by subtracting two weights, preferably two weights which are measured successively. This approach can be repeated multiple times.

In a packaging machine according to the invention, two or more packages are advantageously supplied together to the weighing device, with an individual package, or a number of packages which are to be weighed together, being led away from the entity of the packages which are situated on or in the weighing device. The individual weight of the led-away package or the total weight of said number of packages can subsequently be determined, on the basis of the weight reduction caused by the lead-away, by determining the weight of the remaining package or packages. Said weight reduction is preferably determined by calculation in an evaluating unit by subtraction of two successively-measured weight values. Here, in each case the total weight which is determined after the lead-away of the individual package which is to be weighed, or if the weight of a number of packages is to be determined, after the lead-away of the number of packages which are to be weighed, is subtracted from the total weight determined beforehand.

As a result of the common supply of two or more product packages to the weighing station, a separation device upstream of the weighing device is made superfluous, thereby resulting in a more compact design of the packaging machine.

In one particularly advantageous embodiment of the invention, a weight measurement takes place during the movement of one or more packages.

A dynamic weighing process of said type during the movement of the packages permits, as specified above, a faster throughput than cycle operation, such that the integration of the weighing device into the packaging machine is facilitated. In the above-specified exemplary embodiment, the lead-away unit is accordingly operated continuously, so that the weights which are to be measured are measured during the transport and in particular during the lead-away of the packages from the weighing device.

Here, the lead-away unit can be operated at a moderate speed even in the case of small packages at a high throughput (throughput=items/minute), such that speed-related errors in the weighing process or else also in the subsequent labeling process can be avoided.

In addition to the above-specified dynamic weight measurement, it is also possible for a weight measurement of one or more packages to take place at standstill. Weighing at standstill ensures that no errors resulting from the movement of the packages can occur during the weighing process.

Here, all of the packages which are situated on the weighing device are preferably moved beforehand, with the movement preferably being aligned horizontally. Said measure is an example of how the packages are to be led away or supplied successively by the movement on the weighing device.

In one preferred embodiment, the weighing station is provided with a weighing belt which is driven in circulation continuously or discontinuously. The circulation speed in continuous operation or the cycle speed in the case of discontinuous operation is to be fixed here such that, after the packages whose weight is ultimately to be determined have left the weighing belt, there is sufficient time remaining for the subsequent weight determination.

Continuous belt operation, in which the package or the packages are weighed while being transported, has the additional advantage here that the packages are not subjected to any cycle-induced acceleration or braking processes, so that problems which are caused by this cannot even occur at all, and in particular also the position of the packages on the weighing belt remains undisturbed by such processes.

A transport unit for removal of the packages is preferably arranged downstream of the weighing device. Here, the conveying speed of the downstream transport unit is advantageously selected to be greater than the conveying speed of the conveying unit of the weighing device. As a result, as the packages are passed from the conveying unit of the weighing device to the downstream transport unit, the packages are accelerated, as a result of which the packages can be removed more quickly from the weighing device. If for example the weighing device is provided with a weighing belt for conveying the packages, which weighing belt passes the packages to a downstream transport belt, then the packages are effectively accelerated by the faster-running, downstream transport belt, and are removed here more quickly from the weighing belt.

Said embodiment offers advantages in particular in the case of dynamic weighing, since the idle time, that is to say the time which is required for removing the packages and in which it is not possible to carry out any weighing is shortened by means of said measure. In addition, as a result of said measure, separation takes place downstream of the weighing device on the downstream transport unit, which can if appropriate be utilized in an advantageous manner.

The supply to and/or the lead-away from the weighing receptacle, in particular to and/or from a weighing belt, is preferably carried out such that the packages or the groups of packages which are to be weighed are arranged one behind the other. This permits largely continuous operation, in particular in connection with the above-listed dynamic weighing method.

The conveying unit of the weighing device, in particular in the form of a weighing belt, can however also be of multi-lane design, so that also packages which are placed on the weighing belt in a row transversely with respect to the transport direction can be led away from the weighing belt individually in succession. Devices of said type can be realized for example by means of a plurality of belts or pulleys which circulate adjacent to one another and have separately controllable drives.

The control of the weighing station is to be adapted to the type of supply and lead-away of the packages. It is to be ensured in particular that the respective unit, which can comprise one or more controllable drives, is controlled, as specified above, in such a way that the packages which are to be weighed individually or the desired number of packages which are to be weighed together can be led away or supplied separately from the weighing station in order to be able to utilize the described subtraction weighing method.

In order to obtain the labeling function specified in the introduction, a labeling unit is arranged downstream of the weighing device if required. The transport of product to or through the labeling unit is realized here by means of a corresponding transport unit, for example by means of a transport belt. The labeling unit can on the one hand be supplied with the weight information of the packages which are to be labeled, and on the other hand synchronized with the throughflow of the packages which are to be labeled, either by means of a control unit which is common to the weighing unit, or else by means of a corresponding data and control signal exchange between different control units which communicate via wires or wirelessly.

A sorting unit can if required also be arranged downstream of a weighing unit according to the invention if packages are to be sorted according to weight. This is advantageous in particular if uniform-weight products are to be packed, but deviations sporadically occur. In this case, packages with deviating weight from the uniform-weight packages can be separated out by actuating the sorting device.

For the described subtraction weighing method, it is important, as specified above, for the individual packages or the desired number of packages which are to be weighed together to be led away from the weighing device in succession. When using a continuously circulating weighing belt, it is necessary for this purpose for there to be a predefined spacing between individual packages or individual groups with a certain number of packages which are to be weighed together. Said predefined minimum spacing is required in order to provide, after leaving the weighing belt, a sufficient weighing time for the next weight which is to be determined, before the next package is led away from the weighing belt. In addition, a minimum spacing of said type ensures that the packages do not hinder one another as they are led away from the weighing belt, as would for example be possible in the event of packages which are abutting against one another or which are partially lying one on top of the other.

In order to maintain the desired position of the packages with the predefined minimum spacing, the supply unit which supplies the packages in their entirety to the weighing station is preferably of corresponding design. The supply unit can for this purpose for example be provided with a plurality of pushing elements, with each pushing element engaging on an individual packing and pushing the latter onto the weighing device. The desired minimum spacing between the individual packages can be set by means of a corresponding spacing of the pushing elements, which spacing is greater by the desired minimum spacing than the dimension of the package in the pushing direction.

The flexibility of the device with regard to different package formats can be ensured here for example by means of adjustable or exchangeable pushing elements.

Other supply units are however also conceivable in order to solve the problem of positioning on the weighing belt; it is for example possible to use grippers or vacuum lifters which deposit the packages in the desired position.

A weighing device according to the invention can be particularly advantageously integrated into a packaging machine since no upstream separation unit is necessary. Here, a weighing station according to the invention can easily be supplied, in the cycle of a packaging machine, with the entity of the packagings which are to be led away which are provided by the packaging machine, without it being necessary for complex buffers or separating units to be connected in between. It is necessary merely for the operating speed of the weighing device to be adapted to the working speed of the packaging machine or of the final processing station thereof.

Here, the invention can be used both in machines which seal individual packages (so-called tray sealers) and also in so-called deep-drawing or roller machines which, in one forming process, produce a plurality of interconnected packages from one piece of flat material, and separate the individual packages from one another in a cutting unit only after the sealing process. In machines of said type, it is often the case that an entity of a plurality of packages, which is arranged in rows and columns or lanes, that is to say effectively as a matrix, is provided for the weighing process. A weighing device according to the invention can receive such an overall matrix of packages which are arranged in rows and columns and subsequently weigh said packages by means of separated lead-away. The supply of the entity of packages of a row or of a column is conceivable in such applications, with the different rows or columns then being supplied to the weighing device in succession. A weighing device of said type can therefore be directly integrated into the lead-away path of a packaging machine.

In one particular embodiment of the invention, one or more further inspection units are additionally provided for inspecting the packages which are produced by the packaging machine or system according to the invention. Inspection units of said type can serve for additional quality control. Inspection units of said type can for example be present in the form of a metal detector which serves to check for metallic foreign bodies. A visual inspection can also be expedient depending on the application in order to check the packages for complete labeling or fundamentally for the desired appearance. A leakage station can also be provided as an additional inspection unit.

Various exemplary embodiments of the invention are illustrated in the drawing and are explained in more detail below on the basis of the figures, in which, in detail:

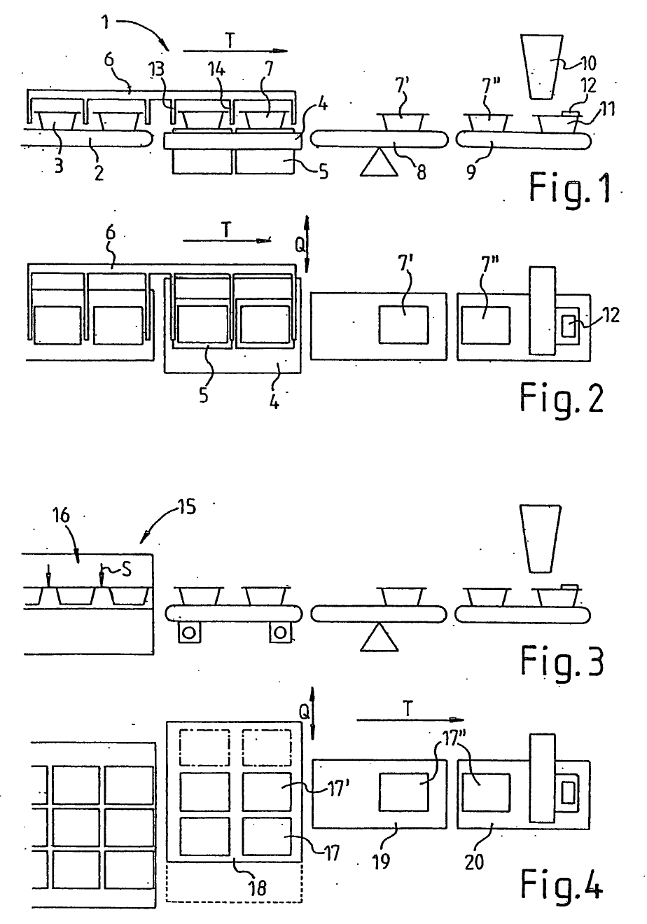

FIG. 1 shows a schematic side view of a first embodiment of the invention,

FIG. 2 shows a plan view of an embodiment as per FIG. 1,

FIG. 3 shows a side view of a second embodiment of the invention,

FIG. 4 shows a plan view of an embodiment as per FIG. 3,

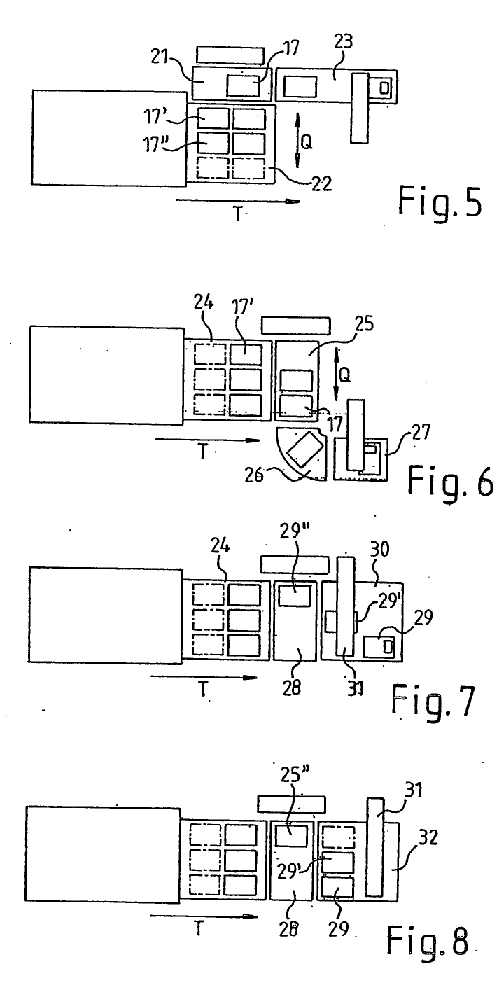

FIG. 5 shows a plan view of a third embodiment of the invention,

FIG. 6 shows a plan view of a fourth embodiment of the invention,

FIG. 7 shows a plan view of a fifth embodiment of the invention, and

FIG. 8 shows a plan view of a sixth embodiment of the invention.

The side view of FIG. 1 partially illustrates a packaging machine 1 according to the invention. It is possible to see the rear end of a filling belt 2 in which the product which is to be packaged is filled into individual trays 3, composed for example of plastic.

Situated downstream of the filling belt 2 in the transport direction T is a tray receptacle 4, which is moveable transversely in a direction Q (cf. FIG. 2), having a lifting unit 5 in order to lower the trays 3 into the tray receptacle 4 or lift said trays 3 out of the tray receptacle 4.

Situated above the rear end of the filling belt 2 and the tray receptacle 4 is a pushing unit 6. The pushing unit 6 is capable of simultaneously pushing a plurality of trays 7, in the present case two trays 7, from the tray receptacle 4 onto a downstream weighing belt 8, and of pushing two trays 3 from the filling belt 2 onto the tray receptacle 4.

An arrangement of said type is known for example in some machines (so-called tray sealers) in which individual separate trays are filled and sealed. The tray receptacle 4 is pushed here in the transverse direction Q with the trays 7 situated therein into a sealing station (not illustrated in any more detail) and, after the sealing process, is placed back into the illustrated position for the removal of the sealed trays 7. Here, it is also possible for two tray receptacles 4 which are moved oppositely to one another to be provided in order to seal the trays of one tray receptacle while the other tray receptacle is emptied and re-filled.

In the present exemplary embodiment, the pushing unit 6 as a supply unit according to the invention accordingly pushes two sealed trays 7 together onto the weighing belt 8.

Arranged downstream of the weighing belt 8 is a labeling belt 9 above which is arranged a labeling unit 10. The labeling unit 10 is capable of printing out labels and applying them to the packages 11 which are to be labeled. A label 12 of said type is illustrated by way of example in the figures.

In the illustration as per FIGS. 1 and 2, only one package 7′ is situated on the weighing belt 8. This is provided in that the trays 7′, 7″ are transported on successively from the weighing belt 8 to the labeling belt 9.

Accordingly, before the illustrated state, the two trays 7′, 7″ were situated together on the weighing belt 8, onto which said trays 7′, 7″ were pushed by means of the pushing unit 6. The tray 7″ has already been conveyed onto the labeling belt by means of the conveying movement of the weighing belt 8 and of the labeling belt 9.

For the determination of the weight of the tray 7″ which has already been led away from the weighing belt 8, an evaluating unit is provided which operates as follows. Firstly, the total weight

$${G}_{ges} = {\sum }_{i = 1}^{n} {G}_{i}$$

where G_{ges} is the total weight, Gᵢ is the weight of the i-th tray and, in the present case, n=2, of both of the trays 7′ and 7″ is determined.

For this purpose, the weighing range of the weighing belt is to be adapted to said total weight, that is to say ≧G_{ges}.

In the illustrated state, after the transport of the tray 7″ on to the labeling belt 9, it is then possible for the individual weight G₁ of the tray 7′, which is now situated alone on the weighing belt, to be determined. By subtracting said individual weight from the total weight,

G₂=G_{ges}−G₁

the weight G₂ of the previously led-away tray 7″ is therefore known at the same time, so that said tray 7″ can be provided with the corresponding weight indication by the labeling unit 10.

If, for the total weight, more than two trays are placed onto the weighing belt, then the determination of the individual weight Gₙ can be carried out successively in the above-described manner, by virtue of in each case the total weight without the individually led-away package being subtracted from the previously determined weight with the most recently led-away package. This results in the general formula

$${G}_{n} = {\sum }_{i = 1}^{n} {G}_{i} - {\sum }_{i = 1}^{n - 1} {G}_{i} .$$

The same method can also be used for groups with a certain number of packages if only the total weight of such a number and not the individual weights of the associated packages are to be determined.

The method thus described is referred to below as the subtraction method.

The pushing unit 6 comprises various pushing elements 13, 14 which have a greater spacing in the transport direction T than the outer dimension of the packages 7. When using the pushing unit 6, the packages 7 abut against the respective pushing elements 13, 14, so that as a result, a defined spacing between the trays 7′, 7″ is generated as the latter are transported onto the weighing belt 8. Said spacing ensures that the trays 7′, 7″ can be led away from the weighing belt 8 individually without disturbing one another, and that the described weighing processes are therefore permitted.

The embodiment as per FIG. 3 corresponds to an arrangement with a so-called roller machine or deep-drawing machine for producing the packages which are to be weighed. Said packaging machine 15 produces a plurality of interconnected packages which are separated from one another in a cutting station 16 by a cutting process. The cutting process is indicated by the arrow S in FIG. 3.

In the case of a packaging machine 15 of said type, a plurality of packages 17 is accordingly always provided in one working cycle. In the present exemplary embodiment, in each case six packages 17 are provided in two rows and three columns with respect to the transport direction. Said matrix-like arrangement of the packages 17 is placed initially on a sliding belt 18 which is moveable in the transverse direction Q transversely with respect to the transport direction T. The sliding belt 18 comprises individual belts or individual pulleys in order to drive the packages 17, 17′, 17″ which are associated with one lane independently from the packages of the other lanes in the transport direction T. In this way, the packages 17, 17′, 17″ are conveyed in each case individually onto a downstream weighing belt 19, which packages are placed upstream of the weighing belt 19 by means of a corresponding transverse movement, in the direction Q, of the sliding belt 18.

At the time illustrated in FIG. 4, two packages 17″ from the first lane have already been moved from the sliding belt 18 onto the weighing belt 19. One package 17″ has already been subsequently transported on onto the labeling belt 20. In addition, the sliding belt 18 has moved further in the transverse direction Q, so that the packages 17′ of the next lane are now ready for being supplied onto the weighing belt 19. By repeating said processes, it is finally also possible for the packages 17 of the final lane to be supplied from the sliding belt 18 to the weighing belt 19.

The weighing process itself and the labeling is subsequently carried out with the subtraction method described above.

The embodiment variant as per FIG. 5 substantially corresponds to the above-specified exemplary embodiment, but with the weighing belt 21 now being arranged laterally adjacent to a discharge belt 22. The supply onto the weighing belt 21 now takes place from the discharge belt 22, which circulates in the transport direction T and from which in each case the packages 17, 17′, 17″ of one lane of the packages which are provided in one working cycle are supplied to the weighing belt 21 in the transverse direction Q. For this purpose, a pushing device (not illustrated in any more detail) which is moveable in the transverse direction Q can be provided. The weighing process on the weighing belt 21 and the downstream labeling belt 23 is carried out in the subtraction method described above.

The embodiment variant as per FIG. 6 again substantially corresponds to the two above-specified exemplary embodiments, but with the discharge belt 24 now circulating in the transport direction T and the weighing belt 25 being arranged, so as to circulate in the transverse direction Q, downstream of the discharge belt 24.

In said embodiment variant, in each case one row of packages 17, 17′ is supplied together to the weighing belt by means of a forward feed of the discharge belt 24. In the illustrated exemplary embodiment, three packages 17 are therefore situated at times on the weighing belt 25.

The lead-away from the weighing belt 25 takes place in the transverse direction Q to a curved conveying element 26 with a labeling belt 27 arranged downstream.

The weighing process itself again takes place in the subtraction method. Firstly, all three of the packages 17 which are situated on the weighing belt 25 are weighed, and the total weight is thus determined. After the first package 17 is led away onto the curved conveying element 26, the total weight of the remaining two packages 17 is weighed, with the individual weight of the already-led-away package 17 being determined by subtraction of said total weight from the previously determined total weight. The two packages 17 which are then still situated on the weighing belt 25 are then likewise determined in the prescribed manner by determining the total weight and subtracting the subsequently determined weight value.

In this embodiment, the labeling process takes place as described above.

The exemplary embodiment as per FIG. 7 shows a comparable arrangement with regard to the discharge belt 24 and the weighing belt 28. However, the weighing belt 28 is now designed for a multi-lane drive, that is to say said weighing belt comprises at least three belts or pulleys which circulate adjacent to one another, so that the packages 29, 29′, 29″ of one row can be successively led away from the weighing belt 28 to the labeling belt. Here, the labeling unit 31 is likewise of multi-lane design, so that each package 29, 29′, 29″ which passes through can be provided with the corresponding weight indication.

The weighing process itself again takes place by means of the above-described subtraction method, in which in each case the individual weight of a led-away package is determined by subtracting the remaining total weight from the previously determined total weight.

The embodiment as per FIG. 8 substantially corresponds to the embodiment as per FIG. 7, with the labeling belt 31 now being operated in cycles. The labeling belt 31 is therefore at standstill until all of the packages 29, 29′ and 29″ of one row have been led away to the labeling belt 31 from the weighing belt 28. Finally, all the packages 29, 29′, 29″ are labeled simultaneously on the labeling belt as they pass together below the multi-lane labeling unit 31.

The illustrated exemplary embodiments show various possibilities for the use of weighing devices according to the invention in packaging machines. All the exemplary embodiments have in common the fact that the supply unit is designed for supplying two or more packages together to the weighing unit, and the lead-away unit is designed for discharging individual packages or individual groups of packages which are to be weighed together, with the weight of the packages which are supplied together being determined.

### LIST OF REFERENCE SYMBOLS

1 Packaging machine
2 Filling belt
3 Tray
4 Tray receptacle
5 Lifting unit
6 Pushing unit
7 Tray
8 Weighing belt
9 Labeling belt
10 Labeling unit
11 Labeled package
12 Label
13 Pushing element
14 Pushing element
15 Packaging machine
16 Cutting station
17 Package
18 Sliding belt
19 Weighing belt
20 Labeling belt
21 Weighing belt
22 Discharge belt
23 Labeling belt
24 Discharge belt
25 Weighing belt
26 Curved conveying element
27 Labeling belt
28 Weighing belt
29 Package
30 Labeling belt
31 Labeling unit
32 Labeling belt

What is claimed is:

1. A packaging machine having a weighing device, with a supply unit for supplying packages containing packaged goods to the weighing device and a lead-away unit for discharging the packages being provided, characterized in that the weight of two or more packages (7′, 7″) and the weight which is changed as a result of the subsequent supply or lead-away of an individual package (7″) or of a number of packages which are to be weighed together are measured, with it being possible for the weight of an individual package (7″) or of a number of packages which are to be weighed together to be determined from the difference between the weights which are determined in this way.

2. The device as claimed in claim 1, characterized in that the weighing range of the weighing device (8) is greater than or equal to the greatest provided total weight of the packages (7′, 7″).

3. The device as claimed in one of the preceding claims, characterized in that an evaluating unit for subtracting two weight values is provided.

4. The device as claimed in one of the preceding claims, characterized in that two successively-measured weight values are subtracted.

5. The device as claimed in one of the preceding claims, characterized in that a weight measurement takes place during the movement of one or more packages (7, 7′, 7″).

6. The device as claimed in one of the preceding claims, characterized in that a weight measurement of one or more packages takes place at standstill.

7. The device as claimed in one of the preceding claims, characterized in that a weight measurement of one or more packages takes place at standstill, with a movement of all of the packages situated on the weighing device having taken place previously.

8. The device as claimed in one of the preceding claims, characterized in that a weighing belt (8) is provided.

9. The device as claimed in one of the preceding claims, characterized in that a control unit for the weighing belt (8) is provided, which control unit is designed for conveying or discharging individual packages (7′, 7″) or a number of packages which are to be weighed together.

10. The device as claimed in one of the preceding claims, characterized in that a transport belt (23) is arranged downstream of and/or upstream of the weighing belt (8).

11. The device as claimed in one of the preceding claims, characterized in that the supply unit (6) has means for spacing apart individual packages (7′, 7″) or individual groups with a certain number of packages.

12. The device as claimed in one of the preceding claims, characterized in that the supply unit comprises a pushing device (6).

13. The device as claimed in one of the preceding claims, characterized in that the pushing device (6) comprises two or more pushing elements (13, 14).

14. The device as claimed in one of the preceding claims, characterized in that the pushing elements (13, 14) have a greater spacing in the pushing direction (T) than the external dimension of the packages (7, 7′, 7″) which are to be weighed.

15. The device as claimed in one of the preceding claims, characterized in that a labeling device (10) is provided.

16. A packaging machine, characterized in that it comprises a weighing unit (8) as claimed in one of the preceding claims.

17. The packaging machine as claimed in one of the preceding claims, characterized in that a supply unit (6) to the weighing device (8) is simultaneously provided as a lead-away unit from a processing station of the packaging machine.

18. A method for weighing packages which are provided by a packaging machine, characterized in that the weight of two or more packages (7′, 7″) and of the weight which is changed as a result of the subsequent supply or lead-away of an individual package (7″) or of a number of packages which are to be weighed together are measured, with the weight of an individual package or of a number of packages which are to be weighed together being determined from the difference between the weights which are determined in this way.
